(19) United States
(12) Patent Application Publication
(10) Pub. No.: US 2021/0388520 A1
(43) Pub. Date: Dec. 16, 2021

(54) METHODS AND SYSTEMS FOR ELECTROCHEMICAL DEPOSITION OF METAL FROM IONIC LIQUIDS INCLUDING IMIDAZOLIUM TETRAHALO-METALLATES

(71) Applicants: Battelle Energy Alliance, LLC, Idaho Falls, ID (US); University of Idaho, Moscow, ID (US)

(72) Inventors: Junhua Jiang, Idaho Falls, ID (US); Haiyan Zhao, Idaho Falls, ID (US); Meng Shi, Idaho Falls, ID (US)

(21) Appl. No.: 17/303,945

(22) Filed: Jun. 10, 2021

Related U.S. Application Data
(60) Provisional application No. 63/037,190, filed on Jun. 10, 2020.

(51) Int. Cl. C25D 3/66; C25D 17/10; C25D 21/14

(52) U.S. Cl. CPC C25D 3/665; C25D 21/14; C25D 17/10

(57) ABSTRACT

An electrochemical deposition system—for the electrochemical deposition of a metal-based material (e.g., aluminum or an aluminum alloy)—comprises an electrolyte solution, at least one working electrode, and at least one counter electrode. The electrolyte solution comprises at least one imidazolium-based tetrahalo-metallate compound (e.g., alkyl methylimidazolium tetrachloroaluminate(s)) and at least one metal-containing compound (e.g., AlCl₃, AlBr₃) of a metal of the metal-based material to be electrodeposited on the at least one working electrode. The working electrode is configured to be exposed to the electrolyte solution. The at least one counter electrode is in contact with the electrolyte solution. In some embodiments, the system is configured for additive manufacturing of the metal-based material being electrochemically deposited. Related methods are also disclosed.

### CROSS-REFERENCE TO RELATED APPLICATION

This application claims the benefit under 35 U.S.C. § 119(e) of U.S. Provisional Patent Application Ser. No. 63/037,190, filed Jun. 10, 2020, pending, the disclosure of which is hereby incorporated in its entirety herein by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure, in various embodiments, relates generally to methods for forming metal-based coatings on a substrate. More particularly, this disclosure relates to methods and systems for forming metal-based coatings by electrochemical deposition involving ionic liquids that include imidazolium-based tetrahalo-metallate(s).

### BACKGROUND

Aluminum (Al) is the most widely used non-ferrous metal. The global production of Al in 2016 was 58.8 million metric tons. It exceeded that of any other metal, except iron. Aluminum is commonly alloyed, and alloying markedly improves its mechanical properties, especially when tempered. Aluminum and its alloys have been successfully, and will be continuously, used for many industries that include, but are not limited to, transportation, packing, electronics, building and construction, machinery, and equipment industries. Emerging applications for aluminum and its alloys such as coatings and energy storage are growing rapidly.

The electrochemical coating market is predominantly driven by the electrical and electronics industry for making electrical device components corrosion and wear resistant, further supported by the automotive industry in which coatings are used for rust protection and brightening of metal and non-metal components. Compared to conventional metal coatings (e.g., zinc (Zn) and nickel (Ni)), aluminum (Al) coating has recently received increasing attention because of its several attributes that include, e.g., high corrosion resistance, superior environmental friendliness, low-risk of hydrogen embrittlement, high electrical conductivity, and high-temperature tolerance. In addition, the anodization of aluminum offers enhanced corrosion resistance and surface durability.

In the nuclear industry, aluminum is often used in a relatively pure (e.g., greater than about 99.0 wt. %) 2S (or 1100) form. In this form, it has been extensively used as a reactor structural material, as a material for fuel cladding, and as material for other purposes, such as those not involving exposure to very high temperatures.

Despite its many advantages, aluminum coating has been used, conventionally, in only limited industrial, commercial, and defense-related applications. In principle, the electrodeposition of Al is more challenging than the electrodeposition of other conventional coating metals. Because Al is a water-sensitive metal and can easily form a passivation oxide layer on the surface, it cannot be deposited from conventional electrolyte baths that are aqueous. Technologically, Al can be deposited from the Hall-Héroult process or its modified processes, which processes are based on molten salt systems. However, molten salt systems are generally high-temperature systems, and operating the processes at high temperatures remains a challenge for achieving aluminum deposition in a cost-affordable manner.

Recently, the electrodeposition of Al in ionic liquids (ILs) has been investigated for a range of potential applications. ILs are a unique class of non-aqueous, ion-conducting, liquid electrolytes with relatively excellent chemical and electrochemical stability. Due to high solvation capability for Al-salt precursors, ionic liquid systems allow the deposition of Al at relatively lower temperatures compared to the temperatures involved in molten salt systems.

Conventional IL-based technologies commonly employ an electroplating bath (e.g., electrolyte solution) comprising an air- and moisture-stable ionic liquid (IL), such as 1-ethyl-3-methylimidazolium chloride ([EMeIm]Cl) or 1-butyl-3-methylimidazonium chloride ([BMeIm]Cl), and an aluminum precursor that is, commonly, aluminum chloride (AlCl₃). With such materials, it has been demonstrated that Al can be successfully electrodeposited. However, standardized and reproducible procedures have not yet been established, due to the challenges associated with the use of inert gas to sustain the deposition process. The success and quality of the resulting electrodeposited aluminum material, using these conventional IL-based systems, tend to be quite sensitive to a number of operational factors, including the composition of the electrolyte mixture (AlCl₃-to-IL ratio), the nature of IL cations and anions, operating temperature, deposition rate, substrate-pretreatment, stirring, and additives. Therefore, electrochemical deposition (e.g., electroplating) of metals, such as aluminum, via ionic liquids continues to present challenges.

### BRIEF SUMMARY

In at least some embodiments, an electrochemical deposition system—for the electrochemical deposition of a metal-based material—comprises an electrolyte solution. The electrolyte solution comprises at least one imidazolium-based tetrahalo-metallate compound. At least one metal-containing compound of a metal, of the metal-based material to be electrodeposited, is also included in the electrolyte solution. At least one working electrode, on which the metal-based material is to be electrodeposited, is configured to be exposed to the electrolyte solution. At least one counter electrode is in contact with the electrolyte solution.

In at least some embodiments, a method for forming a metal-based material on a substrate comprises forming an electrolyte solution comprising an ionic liquid comprising at least one imidazolium-based tetrahalo-metallate material and at least one metal halide. At least one counter electrode is disposed at least partially within the electrolyte solution. The substrate is exposed to the electrolyte solution while an electric current, flowing through the at least one counter electrode and the substrate, is applied or while an electric potential, between at least one reference electrode and the substrate, is applied to electrochemically deposit a metal-based material on at least one surface of the substrate.

In at least some embodiments, an electrochemical deposition system comprises an electrolyte solution within a container. The electrolyte solution consists essentially of a non-aqueous ionic liquid (IL) comprising at least one imidazolium-based tetrachloroaluminate and at least one aluminum salt precursor material. At least one counter electrode is in contact with the electrolyte solution. At least one working electrode is configured to be exposed to the electrolyte solution.

### BRIEF DESCRIPTION OF THE DRAWINGS

FIG. 1 is a schematic illustration of an electrochemical deposition system with an electrochemical cell for electrochemically depositing a metal-based coating on a substrate, in accordance with embodiments of the disclosure, wherein an electrolyte solution includes ionic liquid(s) comprising at least one alkyl methylimidazolium tetrachloro-metallate.

FIG. 2 is a schematic illustration of an electrochemical deposition system for additive manufacturing (e.g., 3D printing) a metal-based coating, on a substrate, by electrochemical deposition, in accordance with embodiments of the disclosure.

FIG. 3 is a cyclic voltammogram measured at 100 mV s⁻¹ for [EMeIm]AlCl₄ on a glassy-carbon (GC) working electrode (substrate) as a function of temperature, in accordance with an example embodiment of the disclosure.

FIG. 4A and FIG. 4B are cyclic voltammograms measured at varying scan rates for a GC electrode in an AlCl₃-[EMeIm]AlCl₄ electrolyte solution with a molar ratio of 1:5 at 30° C. (FIG. 4A) and 110° C. (FIG. 4B), respectively, in accordance with an example embodiment of the disclosure.

FIG. 5 charts the dependence of current densities of the cathode peak on scan rates with data taken from FIG. 4A and FIG. 4B, in accordance with an example embodiment of the disclosure.

FIG. 6 are cyclic voltammograms measured at 100 mV s⁻¹ for a GC electrode in an AlCl₃-[EMeIm]AlCl₄ electrolyte solution with different molar ratios, namely, ratios of 1:5, 1:1, and 1.5:1, respectively, in accordance with an example embodiment of the disclosure.

FIG. 7A and FIG. 7B are current-time transients measured upon stepping potential from the open-circuit potential to a set of deposition potentials, with FIG. 7A being for an operation temperature of 30° C. and with FIG. 7B being for an operation temperature of 110° C., in accordance with an example embodiment of the disclosure.

FIG. 7C and FIG. 7D are the (I/Iₘ)²˜(t/tₘ) plots corresponding to FIG. 7A and FIG. 7B, respectively, with FIG. 7C being for an operation temperature of 30° C. and with FIG. 7D being for an operation temperature of 110° C., in accordance with an example embodiment of the disclosure.

FIG. 8A and FIG. 8B are cyclic voltammograms measured at varying scan rates for a GC electrode in an AlCl₃-[EMeIm]AlCl₄ electrolyte solution with a molar ratio of 1:5 at 30° C. (FIG. 8A, as also graphed in FIG. 4A, but with an additional scan rate of 200 mV/s) and 110° C. (FIG. 8B, as also graphed in FIG. 4B, but with an additional scan rate of 200 mV/s), respectively, in accordance with an example embodiment of the disclosure.

FIG. 8C is a scanning electron microscope (SEM) image of an aluminum (Al) coating layer deposited from the AlCl₃-[EMeIm]AlCl₄ electrolyte solution of FIG. 8B with a molar ratio of 1:5 at 110° C. upon a charge of 2.9 coulomb per square centimeter (C cm⁻²).

FIG. 8D is an SEM image of an aluminum (Al) coating layer deposited from the AlCl₃-[EMeIm]AlCl₄ electrolyte solution of FIG. 8B with a molar ratio of 1:5 at 110° C. upon a charge of 14.5 coulomb per square centimeter (C cm⁻²).

FIG. 8E is an X-ray diffraction pattern (XRD pattern) of an aluminum coating layer formed from the electrolyte solution of FIG. 8B.

FIG. 9A is an SEM image for an Al deposit (e.g., coating) formed on a nickel (Ni) sheet substrate from an electrolyte solution comprising AlCl₃ and 1-ethyl-3-methylimidazolium tetrachloroaluminate at an operation temperature of 180° C., in accordance with an example embodiment of the disclosure.

FIG. 9B is an SEM image for an Al deposit (e.g., coating) formed on a zirconium (Zr) sheet substrate from an electrolyte solution comprising AlCl₃ and 1-ethyl-3-methylimidazolium tetrachloroaluminate at an operation temperature of room temperature (e.g., within a range from about 20° C. (about 68° F.) to about 25° C. (about 77° F.)), in accordance with an example embodiment of the disclosure.

FIG. 10A is an SEM image for an Al deposit (e.g., coating) formed on a copper (Cu) sheet substrate from an electrolyte solution comprising AlBr₃ and 1-butyl-3-methylimidazolium tetrachloroaluminate at an operation temperature of room temperature (e.g., within a range from about 20° C. (about 68° F.) to about 25° C. (about 77° F.)), in accordance with an example embodiment of the disclosure.

FIG. 10B is an SEM image for an Al deposit (e.g., coating) formed on a Cu sheet substrate from an electrolyte solution comprising AlBr₃ and 1-ethyl-3-methylimidazolium tetrachloroaluminate at an operation temperature of room temperature (e.g., within a range from about 20° C. (about 68° F.) to about 25° C. (about 77° F.)), in accordance with an example embodiment of the disclosure.

FIG. 10C is an SEM image for an Al deposit (e.g., coating) formed on a Cu sheet substrate from an electrolyte solution comprising AlBr₃, AlCl₃, 1-butyl-3-methylimidazolium tetrachloroaluminate, and 1-ethyl-3-methylimidazolium tetrachloroaluminate, with a molar ratio of 1:1:1:1, at an operation temperature of room temperature (e.g., within a range from about 20° C. (about 68° F.) to about 25° C. (about 77° F.)), in accordance with an example embodiment of the disclosure.

FIG. 11A is an SEM image for an Al deposit (e.g., coating) formed on a Cu sheet substrate from an electrolyte solution comprising AlBr₃ and 1-butyl-3-methylimidazolium tetrachloroaluminate, and also comprising niobium(V) chloride (NbCl₅) as an inorganic additive, at an operation temperature of room temperature (e.g., within a range from about 20° C. (about 68° F.) to about 25° C. (about 77° F.)), in accordance with an example embodiment of the disclosure.

FIG. 11B is an SEM image for an Al deposit (e.g., coating) formed on a Cu sheet substrate from an electrolyte solution comprising AlBr₃ and 1-butyl-3-methylimidazolium tetrachloroaluminate, and also comprising zirconium(IV) bromide (ZrBr₄) as an inorganic additive, at an operation temperature of room temperature (e.g., within a range from about 20° C. (about 68° F.) to about 25° C. (about 77° F.)), in accordance with an example embodiment of the disclosure.

FIG. 11C is an SEM image for an Al deposit (e.g., coating) formed on a Cu sheet substrate from an electrolyte solution comprising AlBr₃ and 1-butyl-3-methylimidazolium tetrachloroaluminate, and also comprising hafnium(IV) chloride (HfCl₄) as inorganic additive, at an operation temperature of room temperature (e.g., within a range from about 20° C. (about 68° F.) to about 25° C. (about 77° F.)), in accordance with an example embodiment of the disclosure.

FIG. 12A is an SEM image for an Al deposit (e.g., coating) formed on a Cu sheet substrate from an electrolyte solution comprising AlBr₃ and 1-butyl-3-methylimidazolium tetrachloroaluminate, and also comprising bis(cyclopentadienyl)titanium dichloride (C₁₀H₁₀Cl₂Ti) as an organic additive, at an operation temperature of room temperature (e.g., within a range from about 20° C. (about 68° F.) to about 25° C. (about 77° F.)), in accordance with an example embodiment of the disclosure.

FIG. 12B is an SEM image for an Al deposit (e.g., coating) formed on a Cu sheet substrate from an electrolyte solution comprising AlBr₃ and 1-butyl-3-methylimidazolium tetrachloroaluminate, and also comprising triphenyl phosphate ((C₆H₅)₃PO₄) as an organic additive, at an operation temperature of room temperature (e.g., within a range from about 20° C. (about 68° F.) to about 25° C. (about 77° F.)), in accordance with an example embodiment of the disclosure.

FIG. 12C is an SEM image for an Al deposit (e.g., coating) formed on a Cu sheet substrate from an electrolyte solution comprising AlBr₃ and 1-butyl-3-methylimidazolium tetrachloroaluminate, and also comprising acetamide (C₂H₅NO) as an organic additive, at an operation temperature of room temperature (e.g., within a range from about 20° C. (about 68° F.) to about 25° C. (about 77° F.)), in accordance with an example embodiment of the disclosure.

### DETAILED DESCRIPTION

Disclosed are methods and systems for the electrochemical deposition of a metal-based (e.g., aluminum-based) coating on a substrate using an ionic liquid electrolyte solution comprising at least one imidazolium-based tetrahalo-metallate (e.g., alkyl methylimidazolium tetrachloroaluminate(s)). Compared to convention electrochemical deposition (e.g., electroplating) processes, embodiments of the disclosure have the potential to be performed at lower temperatures (e.g., less than about 200° C. (less than about 392° F.), e.g., less than about 180° C. (less than about 356° F.)), e.g., about room temperature (e.g., operation temperatures within a range from about 20° C. (about 68° F.) to about 25° C. (about 77° F.)). The methods and systems also facilitate control of the process chemistry and material handling while allowing the deposition of metal coatings via non-aqueous electrochemical systems. Accordingly, embodiments of the disclosure make use of a class of ionic liquids (IL), namely, imidazolium-based tetrahalo-metallates (e.g., imidazolium-based tetrachloroaluminates), in place of currently-used imidazolium-based chlorides, for the electrodeposition of, e.g., Al. In some embodiments, the systems and methods provide the advantage of there being a fixed 1:1 ratio of imidazolium to tetrahalo-metallate (e.g., tetrachloroaluminate), which 1:1 ratio may facilitate the analysis and control of the process chemistry. Furthermore, tetrahalo-metallates (e.g., 1-ethyl-3-methlimidazolium tetrachloroaluminate ([EMeIm]AlCl₄), 1-butyl-3-methylimidazolium tetrachloroaluminate ([BMeIm]AlCl₄)) may have lower melting points than their corresponding halide counterparts (e.g., 1-ethyl-3-methylimidazolium chloride ([EMeIm]Cl), 1-butyl-3-methylimidazolium chloride ([BMeIm]Cl), respectively), which also facilitates electrodeposition at lower operation temperatures. Lower operation temperatures may facilitate lower operation costs and improved quality coatings formed from the electrochemical deposition.

The illustrations presented herein are not actual views of any particular material, structure, method stage, apparatus, system, or component thereof, but are merely idealized representations that are employed to describe example embodiments of the present disclosure. In contrast, photographs (e.g., micrographs, such as scanning-electron-microscope (SEM) images) are actual views of that which is described. Additionally, elements common between figures may retain the same numerical designation.

The following description provides specific details, such as process conditions and parameters, features, compositions, properties, and/or other characteristics, in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry. In addition, the description provided below may not describe all parameters, conditions, techniques, compositions, or other features of a complete method. Only those parameters, conditions, techniques, compositions, or other method features necessary to understand the embodiments of the disclosure are described in detail below. Additional features and/or acts may be included and/or performed, respectively, according to conventional features and/or techniques, respectively. Also note, the illustrated drawings accompanying the present application are for illustrative purposes only, and are thus not necessarily drawn to scale.

As used herein, the terms “electrochemical deposition” and “electrodeposition” may be used interchangeably.

As used herein, the term “alkyl” means and includes a saturated, straight, branched, or cyclic hydrocarbon containing from one carbon atom to six carbon atoms. Examples include, but are not limited to, methyl, ethyl, propyl, isopropyl, butyl, isobutyl, t-butyl, pentyl, cyclopentyl, isopentyl, neopentyl, hexyl, isohexyl, cyclohexyl hydrocarbon group.

As used herein, the term “high-purity,” when referring to a material comprising a chemical element, compound, or mixture, means and refers to the material comprising at least about 99.0 wt. %, e.g., at least about 99.5 wt. %, e.g., at least about 99.9 wt. %, e.g., at least about 99.99 wt. % the chemical element, the compound, or the mixture, respectively.

As used herein, the qualifier “-based,” when used in association with a material, means and includes such material comprising the material and further comprising at least one other material (e.g., chemical species, chemical element) compounded or mixed therewith. Therefore, a “metal-based” material may be formed of or include an alloy of multiple metals.

As used herein, “room temperature” is a temperature (e.g., an average temperature) within a range from about 20° C. (about 68° F.) to about 25° C. (about 77° F.).

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may,” when used with respect to a material, structure, feature, or method act (e.g., process), indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, arrangement, setting, and/or other characteristic of one or more of a material, structure, apparatus, method technique, and method parameter facilitating, in a predetermined way, a parameter, property, condition, or operation of the one or more of the material, structure, apparatus, method technique, and method parameter.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, the terms “about” or “approximately,” when used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0% to 102.0% of the numerical value, such as within a range of from 95.0% to 105.0% of the numerical value, within a range of from 97.5% to 104.5% of the numerical value, within a range of from 99.0% to 101.0% of the numerical value, within a range of from 99.5% to 100.5% of the numerical value, or within a range of from 99.9% to 100.1% of the numerical value.

As used herein, the singular forms “a,” “an,” and “the” are intended to include the plural forms as well, unless the context clearly indicates otherwise.

As used herein, an “(s)” at the end of a term means and includes the singular form of the term and/or the plural form of the term, unless the context clearly indicates otherwise.

As used herein, the term “and/or” includes any and all combinations of one or more of the associated listed items.

According to embodiments of the disclosure, a metal-based coating (e.g., an aluminum (Al) or aluminum-based (e.g., aluminum alloy) coating) is formed by electrochemical deposition using an ionic liquid (IL) electrolyte solution that include at least one imidazolium-based tetrahalo-metallate (e.g., an alkyl methylimidazolium tetrahalo-metallate, e.g., an alkyl methylimidazolium tetrachloroaluminate).

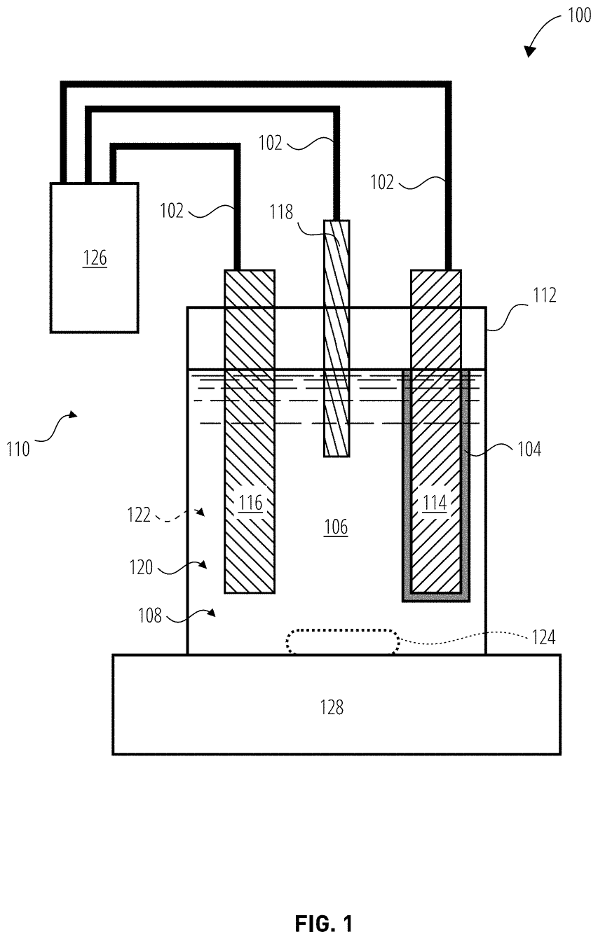

With reference to FIG. 1, illustrated is an electrochemical deposition system 100 for the electrochemical deposition of a coating 104 (e.g., a metal-based coating) onto a substrate in the presence of an electrolyte solution 106 that is an ionic liquid (IL) including at least one imidazolium-based tetrahalo-metallate 108 compound.

The electrochemical deposition system 100 includes an electrochemical cell 110 with at least one container 112 in which the electrolyte solution 106 is contained. In some embodiments, the container 112, the electrochemical cell 110, and or the whole electrochemical deposition system 100 may be further enclosed within a reaction chamber.

The electrochemical cell 110 of the electrochemical deposition system 100 includes multiple electrodes, such as a working electrode (substrate) 114, a counter electrode 116, and, optionally, one or more reference electrodes 118, and is configured for electrochemical deposition of a metal-based coating—the coating 104—upon at least one surface of the working electrode (substrate) 114. In some embodiments, the submerged surface(s) of the working electrode (substrate) 114 may already include one or more electrodeposited materials, whether by embodiments of this disclosure or by other fabrication methods. Therefore, in some embodiments, the exposed surface of the working electrode (substrate) 114 may consist of the material of the working electrode (substrate) 114, while, in other embodiments, the material of the working electrode (substrate) 114 may be spaced from the electrolyte solution 106 and the coating 104 by one or more other layers of material provided the one or more other layers do not inhibit the electrochemical deposition of the coating 104.

The coating 104 may be an elemental metal (e.g., aluminum (Al) (also known as “aluminium” in other countries), cobalt (Co), nickel (Ni), zirconium (Zr), iron (Fe), uranium (U)) or a metal alloy of any of the foregoing elemental metals. In some embodiments, the metal of the coating 104 to be deposited may comprise, consist essentially of, or consist of aluminum (Al) or an aluminum alloy.

Aluminum and aluminum alloy coatings formed according to embodiments of this disclosure may exhibit corrosion and wear resistance in the presence of a relatively greater range of media (e.g., electrolyte compositions) compared to conventional coating materials like zinc (Zn) and nickel (Ni). Aluminum-based coatings may also have relatively high electrical conductivity, have relatively good tolerance to high temperatures, have relatively superior environmental friendliness, and be relatively less likely to experience hydrogen embrittlement. Accordingly, aluminum-based coating materials may be useful in a variety of industries, such as the nuclear industry (e.g., as reactor structural material, as fuel cladding material, material not subjected to extreme temperatures), the gas distribution industry (e.g., a coating on gas-distribution conduits), the automotive industry, the energy-storage industry (e.g., in batteries involving aluminum ions), and other industries making use of aluminum-based materials (e.g., aluminum-based coatings).

In addition to or alternatively to electrodepositing aluminum-based coatings, the electrochemical deposition system 100 and methods of the disclosure may be used to electrodeposit other metal materials such as, e.g., uranium (U) for use in the nuclear industry (e.g., as fuel material), zirconium (Zr) and/or nickel (Ni) coatings for use in automotive and other industrial environments, among others.

The electrolyte solution 106 within the container 112 of the electrochemical cell 110 is formulated as a non-aqueous ionic liquid (IL) that includes at least one imidazolium-based tetrahalo-metallate 108, which may be represented by the formula: [X-Im]MHa₄, wherein “X” represents an alkyl group, “Im” represents an imidazolium group, “M” represents a metal, and “Ha” represents a halogen (e.g., chlorine (Cl), bromine (Br), fluorine (F), iodine (I)). One or more precursor 120 may also be included (e.g., dissolved) in the electrolyte solution 106. In some embodiments, optionally, one or more additives 122 may also be included (e.g., dissolved) in the electrolyte solution 106.

The one or more imidazolium-based tetrahalo-metallates 108 functions as a source of the metal to be deposited in the form of the coating 104. In embodiments in which the coating 104 to be formed is aluminum-based, the “M” of the imidazolium-based tetrahalo-metallate 108 represents aluminum (Al). The imidazolium-based tetrahalo-metallate 108 may be one or more of 1-ethyl-3-methylimidazolium tetrachloroaluminate ([EMeIm]AlCl₄), and 1-butyl-3-methylimidazolium tetrachloroaluminate ([BMeIm]AlCl₄). In some embodiments, the electrolyte solution 106 may include both (e.g., a mixture of) [EMeIm]AlCl₄ and [BMeIm]AlCl₄. In other embodiments, the imidazolium-based tetrahalo-metallate 108 may be formulated or otherwise selected to be relatively long-chain imidazolium tetrahalo-metallate, such as 1-allyl-3-methylimidazolium-tetrahalo-metallate, 1-benzyl-3-methylimidazolium tetrahalo-metallate, and/or 1-hexyl-3-methylimidazolium tetrahalo-metallate.

While some imidazolium-based tetrahalo-metallate compounds have been investigated as to their physical properties, these compounds have not previously been significantly investigated as compounds of electrochemical systems. In developing the embodiments of this disclosure, it was found that including [EMeIm]AlCl₄ in the imidazolium-based tetrahalo-metallate 108 provided an electrolyte solution 106 that exhibited a wide electrochemical window where no Al electrodeposition occurred. However, surprisingly, Al was successfully deposited after adding aluminum chloride (AlCl₃) as a precursor 120 along with the imidazolium-based tetrahalo-metallate 108 in the electrolyte solution 106.

The precursor 120 of the electrolyte solution 106 may be a metal-containing (e.g., metal-based) compound, such as a metal halide and/or a metal complex. For example, in embodiments in which the coating 104 to be formed is aluminum-based, the precursor 120 may comprise, consist essentially of, or consist of a metal halide such as AlCl₃ and/or AlBr₃, and/or the precursor 120 may comprise, consist essentially of, or consist of a metal complex such as trimethylaluminum (Al₂(CH₃)₆ or C₆H₁₈A₂). At least with the inclusion of the precursor 120 in the electrolyte solution 106, in addition to the inclusion of the imidazolium-based tetrahalo-metallate 108, the imidazolium-based tetrahalo-metallate 108 may be suitable for use in the electrolyte solution 106 of an electrochemical deposition process with an electric potential difference (e.g., a “potential window”) range from about 2V to about 4V.

In some embodiments, the electrolyte solution 106 comprises primarily (e.g., at least 50 molar %) of the imidazolium-based tetrahalo-metallate 108. In other embodiments, the electrolyte solution 106 may comprise the imidazolium-based tetrahalo-metallate 108 of a different molar percentage. The molar percentage composed by the imidazolium-based tetrahalo-metallate 108 may be selected or otherwise formulated based on, e.g., the solubility and chemical reactivity of the metal-containing precursor 120.

The electrolyte solution 106 may be substantially free of imidazolium-based halides like imidazolium-based chlorides (i.e., imidazolium-based halide compounds that lack a metal atom), in contrast to imidazolium-based tetrahalo-metallates 108. In some embodiments, at least one compound of the electrolyte solution 106 may have a chemical formula of [XMeIm]MHa₄—rather than [XMeIm]Ha—wherein:

“X” represents an alkyl group (e.g., ethyl, butyl, hexyl) or another substitute group (e.g., allyl, benzyl),

“Me” represents a methyl group,

“Im” represents the imidazolium,

“M” represents the metal, and

Ha₄ represents the tetrahalo group (e.g., tetrachloro (Cl₄), tetrabromo (Br₄)).

At least some tetrahalo-metallates exhibit significantly lower melting points than their corresponding halide counterparts, which lack metal atoms. For example, [BMeIm]AlCl₄ exhibits a melting point of about −10° C. (about 14° F.) and [EMeIm]AlCl₄ exhibits a melting point of about 9° C. (about 48° F.), which are significantly lower melting points than the melting points exhibited by the corresponding chloride counterparts (e.g., the melting points for [EMeIm]Cl and [BMeIm]Cl are about 80° C. (about 176° F.) (e.g., about 77° C. to about 79° C. (about 171° F. to about 174° F.)) and 41° C. (106° F.), respectively). The relatively lower melting points of the tetrahalo-metallates may facilitate lower operating temperatures for the electrochemical deposition process and facilitate process control as controlling lower operation temperatures is generally less of a challenge than controlling higher operation temperatures.

The relatively low melting points of the imidazolium-based tetrahalo-metallate 108 may facilitate electrodeposition of the metal-based coating 104 at temperatures of less than about 180° C. (less than about 356° F.), e.g., less than about 150° C. (less than about 300° F.). In some embodiments, the electrochemical deposition may be carried out at about room temperature (within a range from about 20° C. (about 68° F.) to about 25° C. (about 77° F.)).

Tetrahalo-metallates are also often more readily available, and therefore less expensive, than their halide counterparts. For example, imidazolium-based tetrachloroaluminates are readily available on an industrial scale from commercial sources. Therefore, again, the use of the imidazolium-based tetrahalo-metallate 108 in the electrolyte solution 106 may lower operation costs.

The electrolyte solution 106 may be non-aqueous, such that the electrolyte solution 106, the electrochemical cell 110, and the electrochemical deposition system 100 overall may be substantially free of water. Accordingly, it is contemplated that the metal-based coatings 104 formable by embodiments of the disclosure may exhibit properties (e.g., chemical composition, morphology, uniformity) different from those prepared using conventional aqueous electrolyte solutions.

The one or more precursors 120 of the electrolyte solution 106 may be formulated as a metal-halide (e.g., a salt) and/or as a metal complex of the metal of the coating 104 to be formed. To prepare the electrolyte solution 106, the one or more precursors 120 may be dissolved in the IL that includes the imidazolium-based tetrahalo-metallate 108.

In embodiments in which the metal to be deposited comprises aluminum (Al), the metal precursor(s) 120—dissolved in the electrolyte solution 106—may comprise one or more aluminum salt(s) (e.g., one or more aluminum halide, such as, for example and without limitation, aluminum chloride (AlCl₃) and/or aluminum bromide (AlBr₃)) and/or one or more aluminum complexes (e.g., trimethylaluminum (Al₂(CH₃)₆ or C₆H₁₈Al₂). In some such embodiments, both AlCl₃ and AlBr₃ are used as metal precursors in the electrolyte solution 106. In some further embodiments, a mixture comprising at least one aluminum salt and at least one aluminum complex may be dissolved in the electrolyte solution 106 and used as the precursor(s) 120.

In addition to the one or more imidazolium-based tetrahalo-metallates 108 and the one or more precursors 120, the electrolyte solution 106 may, in some embodiments, include one or more additives 122 dissolved therein. In these embodiments, inorganic and/or organic additives 122 are selected or otherwise formulated to, e.g., change the chemical reactivity of the materials in the electrochemical cell 110, tailor the electrochemical reaction kinetics, and/or adjust the composition of the electrodeposited material (e.g., the material of the coating 104). For example, the one or more additives 122 may be formulated to tailor the chemical interaction between the material of the working electrode (substrate) 114 and a reactive species (e.g., the imidazolium-based tetrahalo-metallate 108, the precursor 120) in the electrolyte solution 106. As another example, the additives 122 may be selected and formulated to produce an electrodeposited material (e.g., the coating 104) that is an desired metal alloy (e.g., aluminum alloy), rather than a high-purity elemental metal (e.g., high-purity aluminum).

Organic additives 122 may be formed of or include one or more halide compound (e.g., chloride compound (e.g., benzene chloride, bis(cyclopentadienyl)titanium dichloride (C₁₀H₁₀Cl₂Ti), bis(cyclopentadienyl)zirconium dichloride (C₁₀H₁₀Cl₂Zr)); alcohol (e.g., benzene alcohol); phosphate (e.g., triphenyl phosphate ((C₆H₅)₃PO₄)); ester; and amide (e.g., acetamide (C₂H₅NO)).

Inorganic additives 122 (e.g., inorganic salts) may be formulated to provide a source for metal ions different than or otherwise in addition to the source for metal ions of the metal to be deposited as the coating 104. The additional metal ions may be selected or otherwise formulated to be reactive with or coordinate with the metal species (of the metal-based material to be deposited as the coating 104) to facilitate the electrochemical deposition and/or to form an electrochemical deposited material (e.g., the coating 104) that is metal-alloy (e.g., an aluminum alloy) rather than an elemental metal. In some embodiments, the inorganic additives 122 may include one or more multi-valence halide, such as—for example, but without limitation—one or more of niobium (Nb) halide(s) (e.g., niobium(V) chloride (NbCl₅)); zirconium (Zr) halide(s) (e.g., zirconium(IV) bromide (ZrBr₄)); titanium halide(s) (e.g., titanium(IV) chloride (TiCl₄); tantalum halides (e.g., tantalum(V) chloride (TaCl₅)); hafnium (Hf) halide(s) (e.g., hafnium(IV) chloride (HfCl₄)); lithium halide(s) (e.g., lithium hexafluorophosphate (LiPF₆), lithium bromide (LiBr)); and sodium halide(s) (e.g., sodium tetrachloroaluminate (e.g., NaAlCl₄)).

In some embodiments, the additive(s) 122 in the electrolyte solution may alternatively or additionally include one or more solvents or other non-imidazolium-based ionic liquid(s). For example, in addition to (or instead of) any of the aforementioned additive 122 materials, the additive 122—and therefore the electrolyte solution 106—may include one or more organic solvents, such as, for example and without limitation, one or more of benzene, benzyl chloride, chloroform, ether(s), and alkyl phosphate(s). As another example, in addition to (or instead of) any of the aforementioned additive 122 materials, the additive 122—and therefore the electrolyte solution 106—may include one or more non-imidazolium-based ionic liquids, such as, for example and without limitation, one or more of pyridinium-based ionic liquids, phosphonium-based ionic liquids, pyrrolidinium-based ionic liquids). Such other additive(s) 122 may be dissolved in the electrolyte solution 106 and may be used to adjust the properties of the deposits (e.g., the coating 104) based on the other additive's 122 influence on the physicochemistry of the electrolyte solution 106, the reactivity of the precursor(s) 120, and the reaction kinetics of the metal's electrodeposition.

Whether organic, inorganic, solvent, or non-imidazolium-based ionic liquid, the inclusion of one or more optional additive 122 in the electrolyte solution 106 may improve the quality of the electrochemical deposition, such as facilitating enhanced adhesion between the material of the coating 104 and the working electrode (substrate) 114, or such as facilitating improved surface morphology. The amount of any or all additives 122 included in the electrolyte solution 106 may be selected or otherwise controlled to be within a range from about 10 ppm to their maximum solubility in the electrolyte solution 106. Therefore, in some embodiments, there may be no additives 122, there may be trace amounts of one or more additive(s), or there may be additive(s) 122 at saturation level(s) in the electrolyte solution 106.

The substrate, upon which the metal-based coating 104 will be formed, may function as the working electrode of the electrochemical cell 110. During the electrodeposition, the working electrode (substrate) 114 more particularly functions as a cathode of the electrochemical cell 110. Therefore, herein, the terms “substrate,” “working electrode,” and “cathode” may be used interchangeably.

The working electrode (substrate) 114 may be formed of and include one or more electrically conductive materials, such as one or more of carbon (C) (e.g., glassy carbon (“GC”)), a metal substrate material (e.g., copper (Cu), iron (Fe), aluminum (Al), zirconium (Zr), alloys including any of the foregoing (e.g., steel, such as stainless steel)), mixtures of any of the foregoing, and other combinations of any of the foregoing. The working electrode (substrate) 114 may be structured substantially flat and planar (e.g., as a sheet), may be rod-shaped, or may be otherwise a three-dimensional structure. The working electrode (substrate) 114 may be porous or nonporous. During the electrodeposition, at least a portion of the working electrode (substrate) 114 is submerged within the electrolyte solution 106 in the container 112 of the electrochemical cell 110, as illustrated in FIG. 1. The coating 104 forms on at least one surface of the working electrode (substrate) 114 that is in contact with the electrolyte solution 106.

The counter electrode 116 functions as the anode during the electrodeposition. Therefore, herein, the terms “counter electrode” and “anode” may be used interchangeably.

The counter electrode 116 may be formed of and include one or more electrically conductive material(s), such as any one or more of the electrically conductive material(s) described above with regard to the working electrode (substrate) 114. The counter electrode 116 may be formed of and include a same or different conductive material as that of the working electrode (substrate) 114. In embodiments in which the coating 104 to be electrodeposited is aluminum-based, the counter electrode 116 may be formed of and include one or more of zirconium (Zr), aluminum (Al), and alloys of any or all the foregoing (e.g., an aluminum alloy).

In embodiments in which at least one reference electrode 118 is included in the electrochemical deposition system 100 the at least one reference electrode 118 may be formed of and include at least one of a metal (e.g., an elemental metal, such as aluminum (Al) or silver (Ag), or a metal-based material (e.g., a metal halide)) and a carbon-based material (e.g., glassy carbon (GC)). In some such embodiments, the at least one reference electrode 118 may be formed of and include more than one metal or metal-based material a metal chloride and a metal (e.g., AgCl and Ag, i.e., an “Ag/AgCl” or an “AgCl/Ag” combination). The at least one reference electrode 118, in contact with the electrolyte solution 106, may be deployed to facilitate control of the electrodeposition process.

Because, as discussed above, the electrolyte solution 106 may be non-aqueous, the range of suitable materials for the working electrode (substrate) 114 and the counter electrode 116 may be selected from a broader range of materials than if the material(s) were to be exposed to an aqueous electrolyte. For example, the working electrode (substrate) 114 may be formed of or include an aluminum alloy that may not otherwise have been suitable in an aqueous electrolyte, and the electrochemical deposition system 100 may be used to electrochemically deposit an aluminum coating (e.g., the coating 104) on an aluminum alloy substrate (e.g., the working electrode (substrate) 114).

Accordingly, disclosed is an electrochemical deposition system for the electrochemical deposition of a metal-based material. The electrochemical deposition system comprises an electrolyte solution. The electrolyte solution comprises at least one imidazolium-based tetrahalo-metallate compound. At least one metal-containing compound a metal, of the metal-based material to be electrodeposited, is also included in the electrolyte solution. At least one working electrode, on which the metal-based material is to be electrodeposited, is configured to be exposed to the electrolyte solution. At least one counter electrode is in contact with the electrolyte solution.

To form the electrolyte solution 106, the one or more precursors 120 may be added (e.g., in solid form, such as in granular, powder, or monolithic form) to the one or more imidazolium-based tetrahalo-metallates 108 and dissolved therein. In embodiments including additives 122, the additive 122 (or additives 122) may be added to the imidazolium-based tetrahalo-metallates 108—or to the imidazolium-based tetrahalo-metallate 108 and precursor 120 mixture—in solid (e.g., powder) or liquid form. The mixture may be agitated within the container 112—such as by an agitator 124 (e.g., magnetic stir rod)—to homogenize the electrolyte solution 106. Agitation may be continued throughout the electrodeposition.

The working electrode (substrate) 114, the counter electrode 116, and the one or more reference electrodes 118 may be at least partially submerged within the electrolyte solution 106 for the electrochemical deposition. Wires 102 may connect each of the electrodes to one or more controllers 126 configured to facilitate control of application of electric current (flowing through the at least one counter electrode 116 and the working electrode (substrate) 114), voltage, or otherwise an electric potential (between the at least one reference electrode 118 and the working electrode (substrate) 114) to cause the deposition of the metal-based material as the coating 104 on the working electrode (substrate) 114. Therefore, during the electrochemical deposition process, an electric current and/or an electric potential difference may be controlled and/or adjusted via control of one or more controllers 126.

Parameters of the electrodeposition process may be tailored to produce the desired quality, composition, and/or morphology of the electrodeposited material (e.g., the material of the coating 104). For example, any one or more of the following may be tailored to produce the resulting coating 104: the composition of the electrolyte solution 106 (e.g., a molar ratio of the imidazolium-based tetrahalo-metallate 108 to precursor 120, such as a molar ratio of about 1:1 or such as a molar ratio within a range from 100 to 0.1; a molar ratio of the additive 122 to the imidazolium-based tetrahalo-metallate 108, such as a ratio within a range from about 1:1 to about 3:1 or greater; the inclusion/exclusion and formulation of the additives 122 and/or impurities); the operating temperature (e.g., an operating temperature within a range from about 20° C. (about 68° F.) to about 180° C. (about 356° F.)); whether or not the working electrode (substrate) 114 or other electrodes are subjected to pretreatment(s); the conditions of the surrounding atmosphere (e.g., within the container 112); the agitation (e.g., via the agitator 124, via a shaker plate, or other means) of the electrolyte solution 106 during the electrodeposition; the electric potential difference between the counter electrode 116 and the working electrode (substrate) 114; the electric current to the electrochemical cell 110; among other parameters.

By adjusting the relative amounts (e.g., molar ratios) of the imidazolium-based tetrahalo-metallate 108, the precursor 120, and, if included, the additives 122, the properties of the resulting electrodeposited metal-based material (e.g., the coating 104) may be controlled, such as the morphology of the material of the coating 104.

In some embodiments, the electrolyte solution 106 may be formulated to have a molar ratio of the metal-salt precursor 120 to the imidazolium-based tetrahalo-metallate 108 of about 1:1, which may facilitate the coating 104 having a consistently uniform and smooth morphology. Therefore, the “quality” of the electrodeposited material may be controlled by adjusting the molar ratio of the components of the electrolyte solution 106. Using the at least one imidazolium-based tetrahalo-metallate 108 as the ionic liquid of the electrolyte solution 106 may facilitate the ratio of the ionic liquid cation to anion of being substantially 1:1, which may ease chemical analysis and control of the electroplating bath (e.g., the electrolyte solution 106) chemistry.

During the electrochemical deposition, metal complexes (e.g., derived from the tetrahalo-metallates) may be formed as intermediaries.

As discussed above, the electrochemical deposition process may be carried out at relatively low temperatures, such as temperatures not exceeding about 160° C. (about 320° F.). In some embodiments, the average operation temperature during the process may be about “room temperature,” e.g., within a range from about 20° C. (about 68° F.) to about 25° C. (about 77° F.). Operating the electrochemical system and electrodepositing the coating 104 at such relatively low temperatures may reduce operating costs. Moreover, electrochemical deposition at lower temperatures may facilitate a higher-quality coating 104 of the deposited material than compared to electrochemical deposition at relatively-high temperatures.

The operating temperature (e.g., average operating temperature) may be tailored in accordance with the materials in the electrochemical deposition system 100 and electrochemical cell 110 (e.g., the material of the working electrode (substrate) 114) and/or the desired properties (e.g., composition, morphology) of the coating 104 to be formed. Controlling the operation temperature(s) may also facilitate control of the morphology of the coating 104 being electrodeposited.

Control of the electric current and/or electric potential difference applied to the counter electrode 116 and the working electrode (substrate) 114 may facilitate control of the electrochemical deposition rate, the control of which may facilitate tailoring of the characteristics of the electrodeposited material (e.g., the coating 104). For example, in embodiments in which the coating 104 is being formed for use in a battery cell, a relatively-fast deposition rate may be desirable and may form the coating 104 with relatively-high porosity. As another example, in embodiments in which the coating 104 is being formed for permanent coating and protection on an underlying structure (e.g., the working electrode (substrate) 114), a relatively slow deposition may be desirable and may form the coating 104 with relatively-low or no porosity.

In some embodiments, the container 112 may be supported by a base structure/device 128 that may play a functional part of the electrodeposition process. For example, in embodiments including the agitator 124 in the container 112 with the electrolyte solution 106, the base structure/device 128 may be configured with magnetic components to cause the agitator 124 to rotate and agitate the electrolyte solution 106. As another example, in some embodiments, the base structure/device 128 is configured as a shaker plate that may be activated to physically move the whole of the container 112 above to agitate the electrolyte solution 106 within the container 112. In some embodiments, in situ or ex situ ultrasonification may be employed to agitate the electrolyte solution 106 within the container 112. In these or other embodiments, the base structure/device 128 may include one or more heating or cooling elements that may facilitate control of the temperature of the electrolyte solution 106. In some embodiments, the base structure/device 128 may be in contact with more than just a base of the container 112.

In some embodiments, prior to the electrodeposition, the working electrode (substrate) 114 may be subjected to a pretreatment act to prime the surface of the working electrode (substrate) 114 for the deposition. Pretreatment may include application (e.g., via the controller 126) of a modulated electric potential, such as a reverse potential pulse, to the working electrode (substrate) 114 in the same electrochemical container 112 in which the electrodeposition is to be performed. Alternatively, the working electrode (substrate) 114 may be pretreated through an out-of-container treatment act, such as pickling. The modulated electric potential may remove surface impurities (e.g., surface oxide) and slightly roughen the surface of the working electrode (substrate) 114 to facilitate the subsequent deposition process.

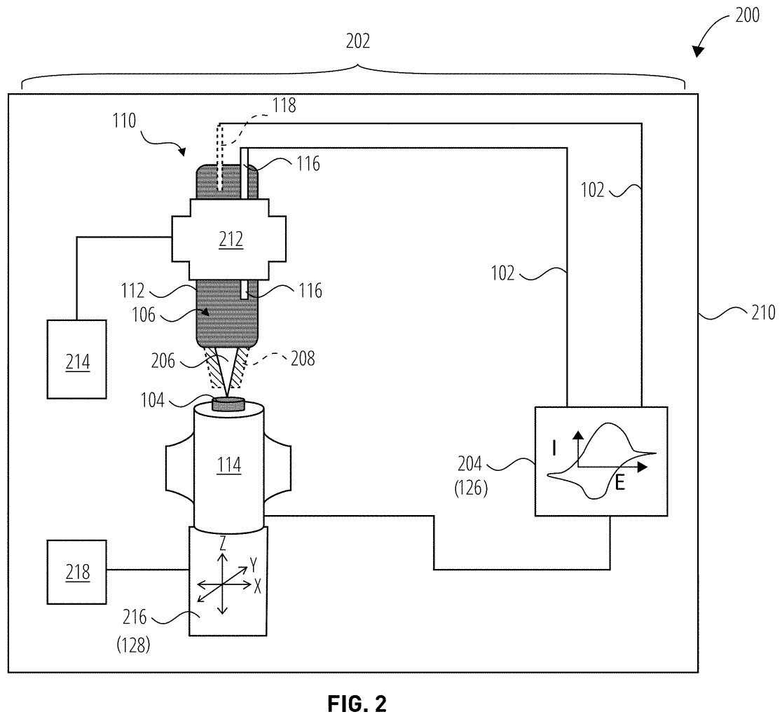

In some embodiments, the electrochemical cell 110 may be part of an additive manufacturing system (e.g., a three-dimensional printer), such as the electrochemical deposition system 200 of FIG. 2. The electrochemical deposition system 200 may include an electrochemical processing unit 202 that includes the electrochemical cell 110 with its container 112 and the electrolyte solution 106 therein. The counter electrode 116 and the one or more reference electrodes 118, if included, may be at least partially submerged within the electrolyte solution 106 in the container 112 of the electrochemical cell 110. The working electrode (substrate) 114 may be outside of the container 112, such as below the container 112 as illustrated in FIG. 2. A first controller 204 (e.g., the controller 126 of FIG. 1) may be configured for use to control the application of an electric potential difference or electric current between the counter electrode 116 and the working electrode (substrate) 114.

At least one nozzle 206 may be coupled to the container 112 and directed toward the working electrode (substrate) 114. In some embodiments, a heater 208 (e.g., an induction heater or a heating block, either of which can be controlled by a temperature control unit) may be coupled to and disposed about the nozzle 206 and/or about the working electrode (substrate) 114. In some embodiments, the heater 208 may comprise an induction heater that laterally surrounds each nozzle 206.

The working electrode (substrate) 114 is configured so as to be exposed to the electrolyte solution 106 for the electrodeposition. For example, the working electrode (substrate) 114 may be disposed proximate to the nozzle 206 with the nozzle 206 directed (or configurable to be directed) toward the working electrode (substrate) 114 such that one or more elements of the electrolyte solution 106 may be deposited through (e.g., expelled through) the nozzle 206 (or nozzles 206) and onto a surface of the working electrode (substrate) 114. Another container, such as a reaction chamber 210, may be included in the electrochemical processing unit 202 and may contain at least the surface of the working electrode (substrate) 114, the coating 104 during its formation, and at least a lowest part of the nozzle 206. Such other container may be formed of steel, glass, plastic, or the like.

One or both of the working electrode (substrate) 114 and the container 112 of the electrochemical cell 110 may be coupled to an electromechanical arm 212 such that the working electrode (substrate) 114 and the container 112 may be configured to move in the x-direction (i.e., left and right, along arrow X, in the view illustrated in FIG. 2), the y-direction (i.e., into and out of the page in the view illustrated in FIG. 2, represented by arrow Y), and the z-direction (i.e., up and down, along arrow Z, in the view illustrated in FIG. 2). In some embodiments, the electromechanical arm 212 may also be configured to rotate. The movement of the electromechanical arm 212 may be controlled via a second controller 214. As the container 112 is moved by the electromechanical arm 212, the nozzle 206 is also moved in the same direction, e.g., over the upper surface of the working electrode (substrate) 114 and along the coating 104 being deposited on the working electrode (substrate) 114.

In some embodiments, the electrochemical processing unit 202 of the electrochemical deposition system 200 also includes an XYZ platform 216 that may support the working electrode (substrate) 114 (and therefore also the coating 104 as it is being formed). Therefore, the XYZ platform 216 may constitute the base structure/device 128 supporting the working electrode (substrate) 114. In such embodiments, the XYZ platform 216 may be configured to be manipulated—such as through control of a third controller 218—to control the movement of the working electrode (substrate) 114 (and therefore also the coating 104) relative to the nozzle 206. Therefore, the third controller 218 and the XYZ platform 216 may be dedicated to control the movement of the working electrode (substrate) 114 (and also the coating 104) while the electromechanical arm 212 and the second controller 214 are dedicated for controlled manipulation of the container (and also the nozzle 206).

In some embodiments, one or more additional controllers may be included in the electrochemical deposition system 200. Any or all of the controllers (e.g., the first controller 204, the second controller 214, and the third controller 218) may be integrated with one another.

While the electrochemical deposition system 100 of FIG. 1 and the electrochemical deposition system 200 of FIG. 2 are illustrated as having a single electrochemical cell 110, the disclosure is not so limited. In other embodiments, multiple electrochemical cells 110, which may or may not be in material communication, may be included in the system(s).

Accordingly, disclosed is a method for forming a metal-based material on a substrate. The method comprises forming an electrolyte solution comprising an ionic liquid comprising at least one imidazolium-based tetrahalo-metallate material and at least one metal halide. At least one counter electrode is disposed at least partially within the electrolyte solution. The substrate is exposed to the electrolyte solution while applying an electric current flowing through the at least one counter electrode and the substrate, or while applying an electric potential between at least one reference electrode and the substrate, to electrochemically deposit a metal-based material on at least one surface of the substrate.

Furthermore, also disclosed is an electrochemical deposition system comprising an electrolyte solution within a container. The electrolyte solution consists essentially of a non-aqueous ionic liquid (IL) comprising at least one imidazolium-based tetrachloroaluminate and at least one aluminum salt precursor material. At least one counter electrode is in contact with the electrolyte solution. At least one working electrode is configured to be exposed to the electrolyte solution.

### EXAMPLES

### Example I: Aluminum Electrodeposition with [EMeIm]AlCl₄—AlCl₃ Electrolyte Solution

The electrodeposition of Al was studied, with the aluminum being electrodeposited from an electrolyte solution 106 of an ionic liquid bath employing 1-ethyl-3-methylimidazolium tetrachloroaluminate ([EMeIm]AlCl₄) as the imidazolium-based tetrahalo-metallate 108 and AlCl₃ as the precursor 120 through electrochemical measurements and materials characterization. In trials not including the precursor 120, and with an operation temperature range of 30° C. (86 F) to 110° C. (230° F.), the [EMeIm]AlCl₄ (e.g., imidazolium-based tetrahalo-metallate 108) exhibited a wide electrochemical window where no Al electrodeposition occurred on a glassy carbon (GC) electrode (e.g., the working electrode (substrate) 114). Adding AlCl₃ (e.g., the precursor 120) to the [EMeIm]AlCl₄ in the electrolyte solution 106 generated obvious redox peaks in cyclic voltammograms, corresponding to the Al deposition and dissolution, and well-developed nucleation-growth loops in current-time transients. The characterization of the deposits were prepared through constant-potential cathode polarization by scanning-electron-microscope (SEM), energy dispersive spectroscope (EDS), and X-ray diffraction (XRD) microscope and clearly showed that metallic Al had been successfully deposited from the AlCl₃-[EMeIm]AlCl₄ system. These results indicated that the [EMeIm]AlCl₄ was an effective ionic liquid for the Al electrodeposition.

Chemicals and Instruments:

All chemicals were used as received without further purification. During electrochemical measurements, AlCl₃ (99%, Alfa Aesar) was added (e.g., as the precursor 120) into [EMeIm]AlCl₄ (>95%, Sigma Aldrich) (e.g., the imidazolium-based tetrahalo-metallate 108) at an appropriate molar ratio. The working electrode (working electrode (substrate) 114) was a 1 mm diameter glassy carbon (GC) disk electrode with a PEEK shroud. Both the counter electrode 116 and the reference electrode 118 were made from 1 mm diameter Al wire (99.9995% metal basis, Alfa Aesar). A VersaSTAT 4 Potentiostat (Princeton Applied Research) was used for all electrochemical measurements and preparation. The temperature of the cell (e.g., the electrochemical cell 110) was controlled to ±1° C. using a block heater (Techne DRI-BLOCK® Digital Block Heater) (e.g., the base structure/device 128).

Electrochemical Measurements and Deposition:

Before all electrochemical measurements, the [EMeIm]AlCl₄ (e.g., the imidazolium-based tetrahalo-metallate 108) electrolyte (e.g., electrolyte solution 106), with or without added AlCl₃ (e.g., the precursor 120), was pre-heated at 110° C. (230° F.) for approximately 2 hours to remove moisture. This was followed by the electrode treatment in the electrolyte (e.g., the electrolyte solution 106), performed by holding the potential at 2.0 V to remove surface impurities from the working electrode (substrate) 114. During cyclic voltammetric measurements, base cyclic voltammograms for the GC electrode (e.g., the working electrode (substrate) 114) were measured at 100 mV s⁻¹ in [EMeIm]AlCl₄ (e.g., the imidazolium-based tetrahalo-metallate 108). Cyclic voltammograms for the AlCl₃ (e.g., the precursor 120) on the GC electrodes (e.g., the working electrode (substrate) 114) were performed under controlled conditions after adding AlCl₃ (e.g., the precursor 120) to [EMeIm]AlCl₄ (e.g., the imidazolium-based tetrahalo-metallate 108) at an appropriate ratio. Their dependence on the reaction temperature and the AlCl₃ concentration were studied at 100 mV s⁻¹. For the nucleation-growth studies of the Al deposition (e.g., the coating 104), current-time transients were measured by stepping the potential from the open-circuit potential (OCP) to a set of deposition potentials. All potentials reported were versus the Al reference electrode (e.g., the reference electrode 118) unless otherwise stated.

During each preparative deposition, a constant potential was applied to the GC electrode (e.g., the working electrode (substrate) 114) until a controlled charge was reached. After the deposition, the GC electrode (e.g., the working electrode (substrate) 114) was taken out from the electrochemical cell (e.g., the electrochemical cell 110) and the deposit (e.g., the coating 104) was repetitively washed using a sufficient amount of acetonitrile or acetone, followed by air-drying before its characterization.

Materials Characterization:

The morphology and elemental composition of Al deposits (e.g., the coating 104) were studied using a JEOL JSM-6610LV scanning electron microscope (SEM) operating at 20 kV, equipped with an Apollo SDD X-Ray spectrometer. X-ray diffraction (XRD) measurements of Al deposits (e.g., the coating 104) were performed on a Rigaku SMARTLAB™ X-ray diffractometer using a Cu Kα radiation (also known as “CuKα radiation” and “Cu K(alpha) radiation”).

### Results and Discussion

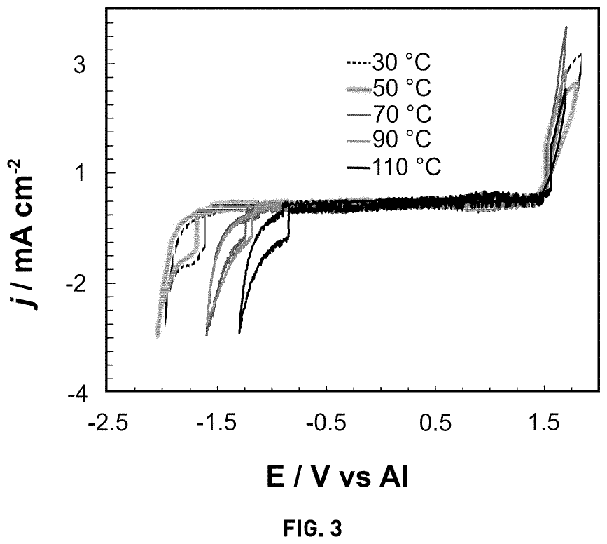

FIG. 3 shows the base voltammograms for a GC electrode (e.g., the working electrode (substrate) 114) in [EMeIm]AlCl₄ (e.g., the imidazolium-based tetrahalo-metallate 108) without containing AlCl₃ (e.g., the precursor 120) at different temperatures. They display rather flat zones between the fast-growing oxidation and reduction currents, as well as very close onset potentials for considerable oxidation-current growth. In contrast, the onset potentials for the reduction-current growth are strongly dependent on temperature, characteristic of their positive shift with increasing temperature. Based on the onset potential difference for the oxidation and reduction current growth, the values of electrochemical windows for [EMeIm]AlCl₄ (e.g., the imidazolium-based tetrahalo-metallate 108) on the GC electrode (e.g., the working electrode (substrate) 114) were measured. The electrochemical windows decreased from approximately 3.2 V to 2.3 V as the temperature increased from 30° C. (86° F.) to 110° C. (230° F.). These results are consistent with literature data measured under similar conditions. In the electrochemical windows, no oxidation peak associated with the anodic oxidation was discerned. This strongly indicated that the complex species bearing Al was stable and that no metallic Al was formed in the cathodic scans, although small abrupt reduction currents were observed.

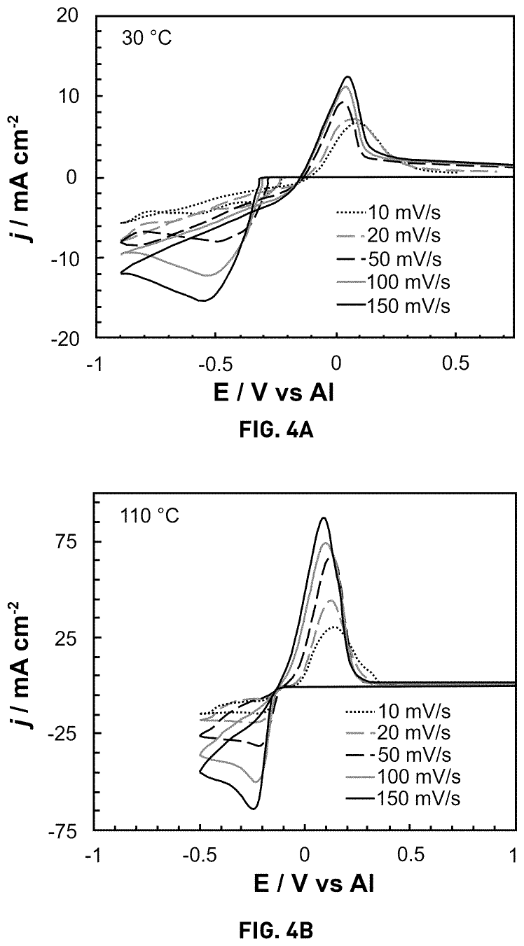

The introduction of AlCl₃ (e.g., the precursor 120) to [EMeIm]AlCl₄ (e.g., the imidazolium-based tetrahalo-metallate 108) at a molar ratio of 1:5 generated oxidation and reduction current peaks within the electrochemical windows mentioned above in the voltammograms, as shown in FIG. 4A and FIG. 4B. By reference to literature results, the reduction peaks appear to correspond to the deposition of Al (e.g., the coating 104) and the oxidation peaks are caused by the anodic dissolution of Al. Their onset deposition potentials are approximately −0.32 V at 30° C. (86° F.) and −0.11 V at 110° C. (230° F.). Both the voltammograms exhibit increased peak current densities (jₚ) with increasing scan rate (ν).

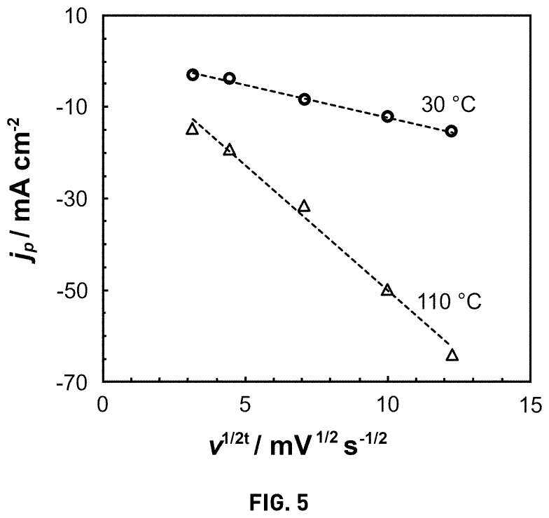

The relationship between the cathodic peak current densities and the square of scan rate is shown in FIG. 5. Good linearity was observed for both 30° C. (86° F.) and 110° C. (230° F.), indicating that the cathode reaction is diffusion-controlled. The jₚ˜ν^{1/2} equation for an irreversible electrochemical reaction is as follows:

jₚ=(2.99×10⁵)n(αn)^{1/2}CD^{1/2}ν^{1/2} (1)

wherein “C” and “D” are the centration of active Al complex and its diffusion coefficient, respectively, and other terms have their normal meaning. Assuming that n=3, αn=0.5, and AlCl₃ is in the form of [Al₂Cl₇]⁻, the values of D were estimated to be approximately 2.1×10⁻⁸ cm² s⁻¹ at 30° C. (86° F.) and 2.6×10⁻⁷ cm² s⁻¹ at 110° C. (230° F.). Due to the complicated nature of the intermediates involved in the Al deposition, there are very limited literature data. Lai et al., “Electrodeposition of Aluminium in Aluminium Chloride/1-methyl-3-ethylimidazolium chloride,” J. Electroanal. Chem., Vol. 248 (1988), 431-440, reported the D value of [Al₂Cl₇]⁻ was about 6.2×10⁻⁸ cm² s⁻¹ at 40° C., while Carlin et al., “Microelectrodes in the Examination of Anodic and Cathodic Limit Reactions of an Ambient Temperature Molten Salt,” J. Electroanal. Chem., Vol. 252 (1988), 81-89, reported a D value of 6.1×10⁻⁷ cm² s⁻¹ at approximately 30° C. for Cl⁻ in a similar system.

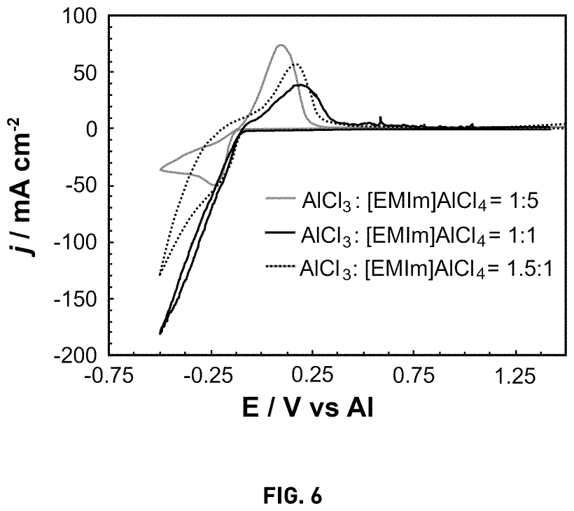

Increasing the ratio of AlCl₃ (e.g., the precursor 120) to [EMeIm]AlCl₄ (e.g., the imidazolium-based tetrahalo-metallate 108) substantially changed the voltammetric characters associated with the reduction currents, as shown in FIG. 6. The use of 1:1 ratio led to the disappearance of the cathodic peak that was seen for the 1:5 ratio case. The reduction currents changed almost linearly with varying potential. Further increasing the ratio to 1.5:1 resulted in different reduction-current and potential responses. In the three cases, similar oxidation peaks were seen in the positive scans. However, the peak currents showed slight decreases when more AlCl₃ (e.g., the precursor 120) was added to [EMeIm]AlCl₄ (e.g., the precursor 120). Without being bound to any theory, the unusual changes may be related to the mass of Al attached on the GC electrode (e.g., the working electrode (substrate) 114), which contributes to the peak currents, as well as the form of the intermediates bearing Al. In an AlCl₃-[EMeIm]Cl system, it has been suggested that the primary form of the intermediate changes with the variation of the AlCl₃ to [EMeIm]Cl ratio. Accordingly, the form of the intermediates—in the precursor 120 and imidazolium-based tetrahalo-metallate 108 electrolyte solution 106 of embodiments of the disclosure—may be impacted by the precursor 120 to imidazolium-based tetrahalo-metallate 108 ratio.

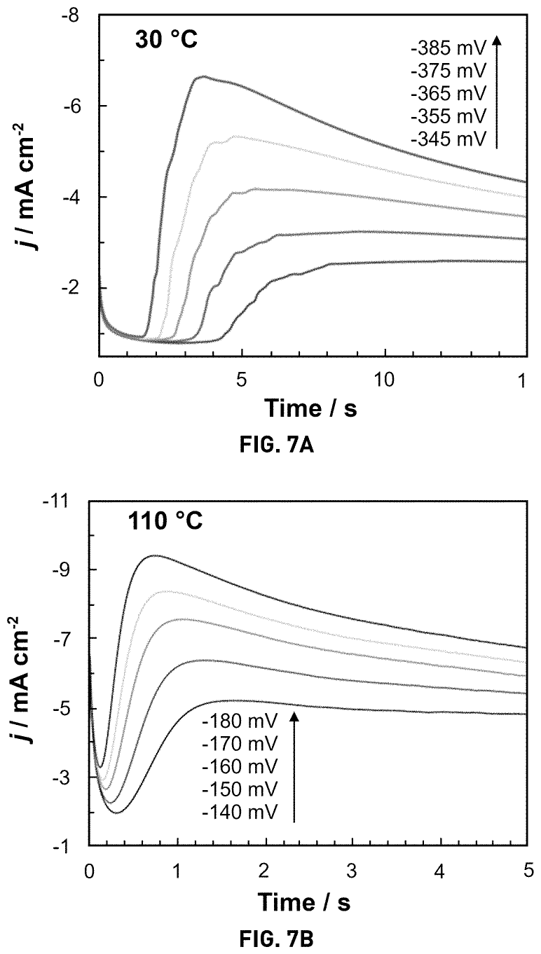

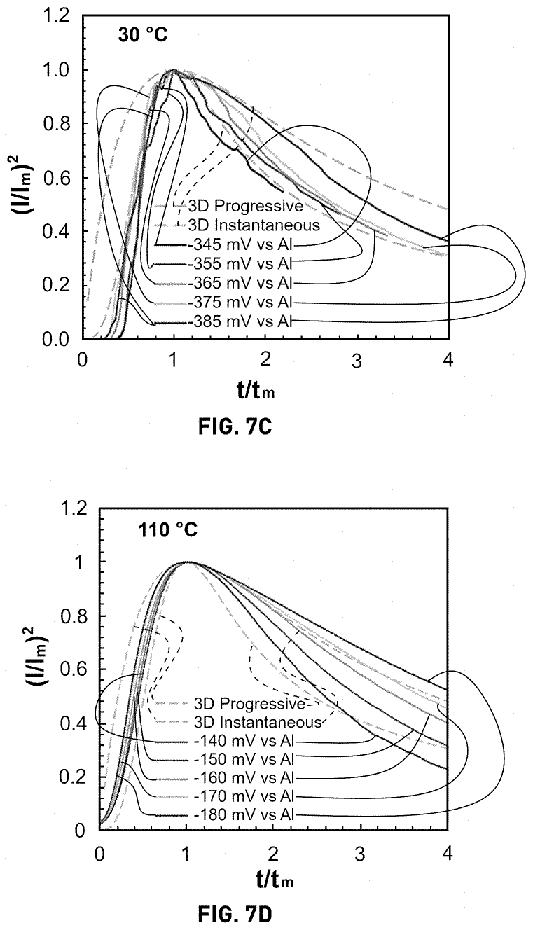

The potentiostatic current-time profiles for the Al deposition (e.g., the coating 104) on the GC electrode (e.g., the working electrode (substrate) 114) in the AlCl₃-[EMeIm]AlCl₄ electrolyte solution 106 upon a potential step from the OCP to a set of polarization potentials at 30° C. (86° F.) and 110° C. (230° F.) are shown in FIG. 7A and FIG. 7B, respectively. At lower potentials, the transients are characterized by initial current decay, a current minimum and then gradual growth until a plateau is seen. Increasing the potential enables these properties to be seen at shorter times and leads to the appearance of a current maximum followed by slow decay at longer times. Initial stages of metal deposition are usually associated with a three-dimensional (3D) nucleation. For diffusion controlled 3D instantaneous and progressive nucleation, the following expressions are normally applied (Eqs. 2 and 3).

$$\begin{matrix}{( \frac{j}{{j}_{m}} )}^{2} = 1.9542 {( t / {t}_{m} )}^{- 1} {\{ 1 - exp [ - 1.2564 ( t / {t}_{m} ) ] \}}^{2} & ( 2 ) \\ {( \frac{j}{{j}_{m}} )}^{2} = 1.2254 {( t / {t}_{m} )}^{- 1} {\{ 1 - exp [ - 2.3367 {( t / {t}_{m} )}^{2} ] \}}^{2} & ( 3 )\end{matrix}$$

wherein “j” is the current density at any time “t,” and “jₘ” is the maximum current density at “tₘ” time.

FIG. 7C and FIG. 7D show non-dimensional plots of the experimental current transients at different potentials for the Al deposition (e.g., coating 104) onto the GC electrode (e.g., the working electrode (substrate) 114) at 30° C. (86° F.) and 110° C. (230° F.) in comparison with theoretical curves from Eqs. 2 and 3. The nucleation plots have a close correlation with the theoretical curve for the progressive nucleation (e.g., the “3D Progressive” lines) at lower potentials applied. These nucleation kinetics are different from literature results for the Al deposition from AlCl₃-[EMeIm]Cl, which exhibits a better fit with the 3D instantaneous nucleation (e.g., the “3D Instantaneous” lines).

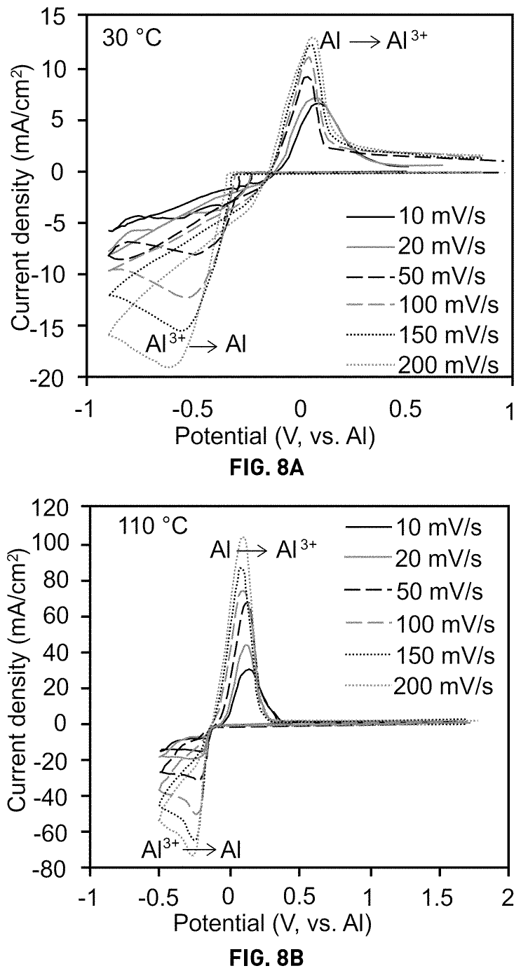

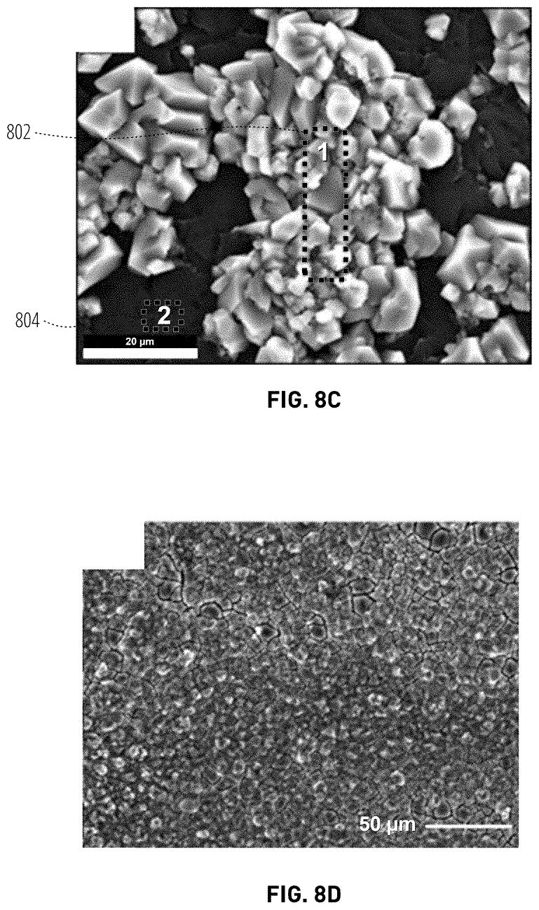

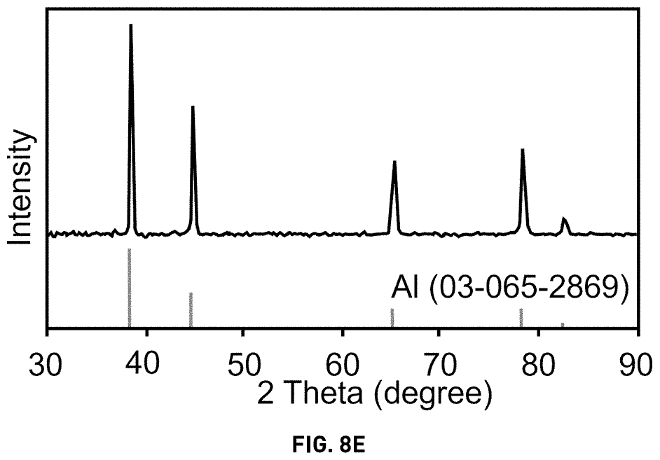

FIG. 8A and FIG. 8B are voltammograms with the same plots of FIG. 4A and FIG. 4B, respectively, but further including a data line for 200 mV s⁻¹.

FIG. 8C and FIG. 8D show the SEM images of Al layers (e.g., coatings 104) deposited under constant-potential polarization at 110° C. (230° F.) after the charge reached 2.9 C cm⁻² and 14.5 C cm⁻², respectively. The thin deposit layer exhibited the bright region comprising aggregated polyhedral particles and the black region. Further growth of the deposit layer (e.g., the coating 104) led to the complete coating of the substrate (e.g., the working electrode (substrate) 114), accompanied by the formation of minor cracks. The elemental analysis (Table I, below) of the bright zone (dotted area 1802) and the dark zone (dotted area 2804) annotated in FIG. 8C disclosed that the polyhedral particles were 100% Al, and the black zone corresponded to the GC substrate (e.g., the working electrode (substrate) 114):

TABLE I

| Area | Element | Weight % | Atomic % |
|---|---|---|---|
| 1 | Al | 100.00 | 100.00 |
| 2 | C | 99.65 | 99.86 |
| | Al | 0.25 | 0.11 |
| | Cl | 0.10 | 0.03 |

The XRD patterns of a thick Al layer (e.g., coating 104) deposited at the same temperature are shown in FIG. 8E. They match well with the standard values for Al in JCPDS (card #03-065-2869), indicative of a face-centered-cubic (fcc) structure responsible for observed [111], [200], [220], [311] and [222] patterns. This strongly supported the deposition of metallic Al (e.g., as the coating 104) during the cathode polarization.

Accordingly, the electrolyte solution 106, with [EMeIm]AlCl₄ (e.g., the imidazolium-based tetrahalo-metallate 108) as the ionic liquid electrolyte and AlCl₃ as the precursor 120, for the electrodeposition of Al (e.g., as the coating 104) has been shown by these examples. Because of its wide electrochemical window and low melting point, the [EMeIm]AlCl₄ (e.g., as the imidazolium-based tetrahalo-metallate 108) is a prospective ionic liquid for the electrodeposition of Al.

### Example II: Al Deposition on Other Substrates (Besides Copper and Glassy Carbon)

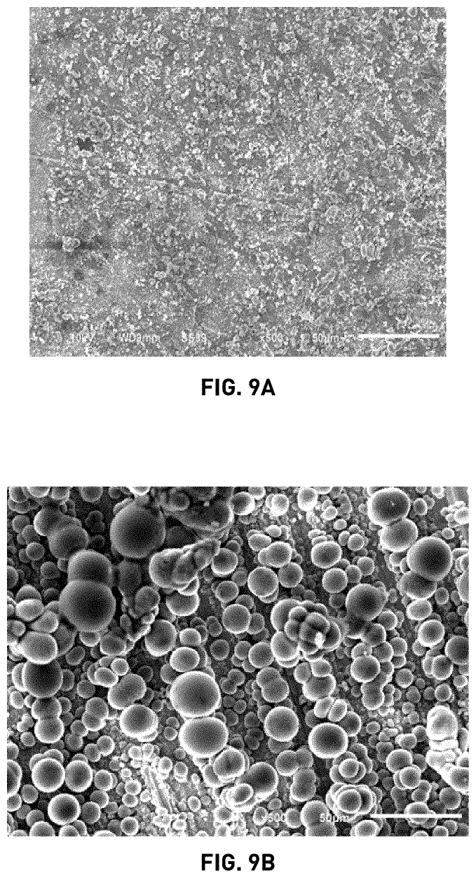

FIG. 9A is an SEM image of Al deposits (e.g., coating 104) formed on a nickel (Ni) sheet (e.g., the working electrode (substrate) 114) from an electrolyte solution 106 comprising AlCl₃ (e.g., as the precursor 120) and 1-ethyl-3-methylimidazolium tetrachloroaluminate (e.g., as the imidazolium-based tetrahalo-metallate 108) at 180° C. (356° F.). This image indicates that an elevated temperature could be useful to facilitate the deposition of fine Al particles onto an inert substrate (e.g., Ni).

FIG. 9B is an SEM image of Al deposits (e.g., coating 104) formed on a zirconium (Zr) sheet (e.g., the working electrode (substrate) 114) from an electrolyte solution 106 comprising AlCl₃ (e.g., as the precursor 120) and 1-ethyl-3-methylimidazolium tetrachloroaluminate (e.g., as the imidazolium-based tetrahalo-metallate 108) at room temperature. This image indicates that the coating of Al onto Zr-based structural materials is feasible and that the morphology of the Al deposit is substrate-dependent, compared to the deposition of Al on other substrates. Furthermore, it is contemplated that a Zr-based substrate may be usable to form Al spheres.

### Example III: Deposition with Different Al Precursors and/or Different Ionic Liquids

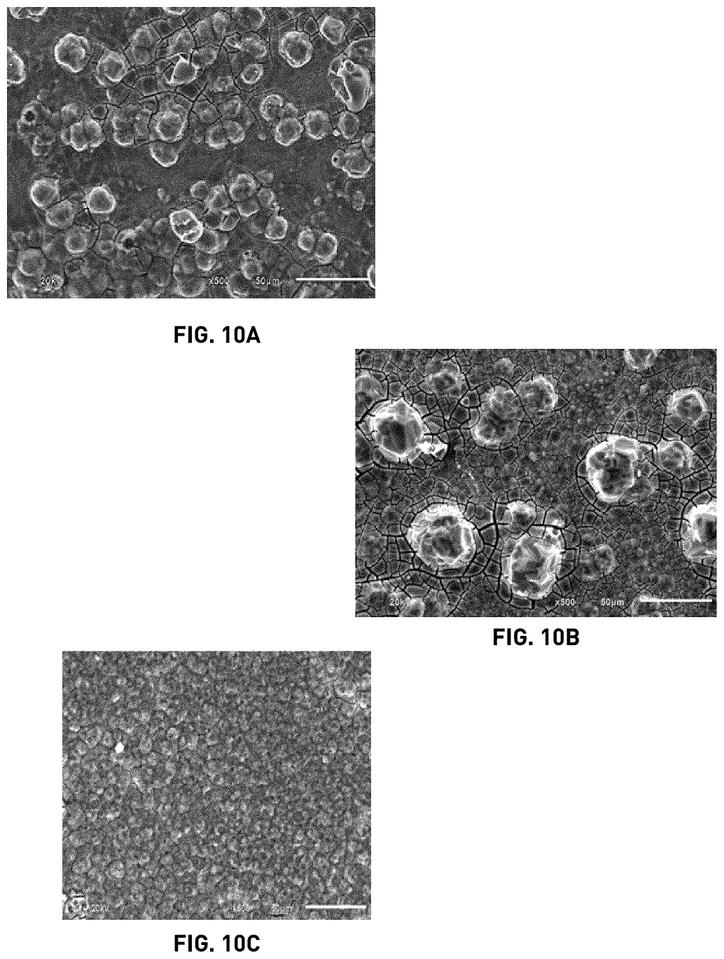

FIG. 10A is an SEM image of Al deposits (e.g., coating 104) formed on a copper (Cu) sheet (e.g., the working electrode (substrate) 114) from an electrolyte solution 106 comprising AlBr₃ (e.g., as the precursor 120) and 1-butyl-3-methylimidazolium tetrachloroaluminate (e.g., as the imidazolium-based tetrahalo-metallate 108) at room temperature. This image indicates that the precursor AlBr₃ is capable of dissolving in 1-butyl-3-methylimidazolium tetrachloroaluminate and that room-temperature deposition of Al is achievable. Based on these results, it is contemplated that AlBr₃ is a promising precursor for Al deposition from different tetrahalo-metallate-based ionic liquids.

FIG. 10B is an SEM image of Al deposits (e.g., coating 104) formed on a copper (Cu) sheet (e.g., the working electrode (substrate) 114) from an electrolyte solution 106 comprising AlBr₃ (e.g., as the precursor 120) and 1-ethyl-3-methylimidazolium tetrachloroaluminate (e.g., as the imidazolium-based tetrahalo-metallate 108) at room temperature. This image, in comparison to that of FIG. 10A, demonstrates that the use of an AlBr₃ precursor in a different ionic liquid (e.g., 1-ethyl-3-methylimidazolium tetrachloroaluminate of FIG. 10B), rather than the 1-butyl-3-methylimidazolium of FIG. 10A) results in an Al deposit with a different morphology.

FIG. 10C is an SEM image of Al deposits (e.g., coating 104) formed on a copper (Cu) sheet (e.g., the working electrode (substrate) 114) from an electrolyte solution 106 comprising AlBr₃ and AlCl₃ (e.g., as the precursors 120) and 1-butyl-3-methylimidazolium tetrachloroaluminate and 1-ethyl-3-methylimidazolium tetrachloroaluminate (e.g., as the imidazolium-based tetrahalo-metallates 108) with a molar ratio of 1:1:1:1 at room temperature. These results indicate that the use of mixed precursors 120 (e.g., AlCl₃ and AlBr₃) and mixed imidazolium-based tetrahalo-metallates 108 (e.g., the 1-butyl-3-methylimidazolium tetrachloroaluminate and 1-ethyl-3-methylimidazolium tetrachloroaluminate) may facilitate formation of an Al coating (e.g., the coating 104) with a uniform and smooth surface. From the results, it is contemplated that tailoring or control of the properties of the metal deposit (e.g., the coating 104) may be facilitated by including, in the electrolyte solution 106, a mix of different precursors 120 (e.g., AlCl₃ and AlBr₃) along with a single imidazolium-based tetrahalo-metallate 108 (e.g., the 1-butyl-3-methylimidazolium tetrachloroaluminate or the 1-ethyl-3-methylimidazolium tetrachloroaluminate) or by including, in the electrolyte solution 106, a single precursor 120 (e.g., AlCl₃ or AlBr₃) along with a mix of imidazolium-based tetrahalo-metallates 108 (e.g., the 1-butyl-3-methylimidazolium tetrachloroaluminate and the 1-ethyl-3-methylimidazolium tetrachloroaluminate).

### Example IV: Deposition Using Inorganic Additives

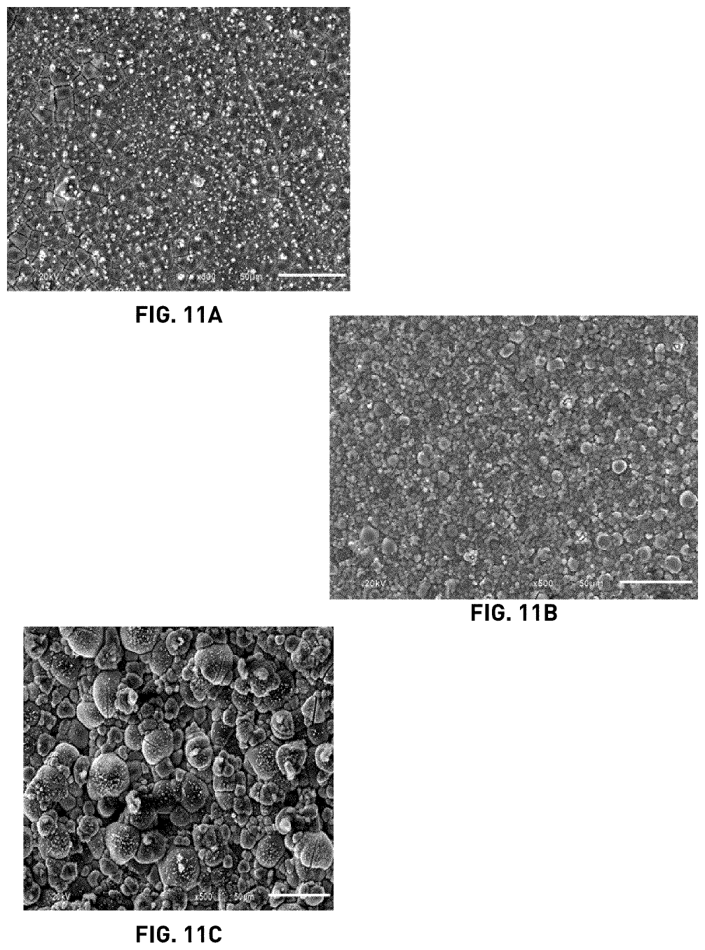

FIG. 11A is an SEM image of Al deposits (e.g., coating 104) formed on a copper (Cu) sheet (e.g., the working electrode (substrate) 114) from an electrolyte solution 106 comprising AlBr₃ (e.g., as the precursor 120) and 1-butyl-3-methylimidazolium tetrachloroaluminate (e.g., as the imidazolium-based tetrahalo-metallate 108) with niobium(V) chloride (NbCl₅) as an inorganic additive 122 at room temperature. These results indicate that the use of a NbCl₅ inorganic additive 122 may decrease the formation of large particles (e.g., of the metal (e.g., Al)) in the deposit (e.g., the coating 104). This may be the result of interactions between the NbCl₅ inorganic additive 122, the precursor 120, and the imidazolium-based tetrahalo-metallate 108 adjacent to the surface of the working electrode (substrate) 114.

FIG. 11B is an SEM image of Al deposits (e.g., coating 104) formed on a copper (Cu) sheet (e.g., the working electrode (substrate) 114) from an electrolyte solution 106 comprising AlBr₃ (e.g., as the precursor 120) and 1-butyl-3-methylimidazolium tetrachloroaluminate (e.g., as the imidazolium-based tetrahalo-metallate 108) with zirconium(IV) bromide (ZrBr₄) as an inorganic additive 122 at room temperature. These results indicate that the use of a ZrBr₄ inorganic additive may facilitate the formation of relatively flat metal deposits (e.g., the coating 104) comprising microspheres of the metal (e.g., the Al).

FIG. 11C is an SEM image of Al deposits (e.g., coating 104) formed on a copper (Cu) sheet (e.g., the working electrode (substrate) 114) from an electrolyte solution 106 comprising AlBr₃ (e.g., as the precursor 120) and 1-butyl-3-methylimidazolium tetrachloroaluminate (e.g., as the imidazolium-based tetrahalo-metallate 108) with hafnium(IV) chloride (HfCl₄) as an inorganic additive 122 at room temperature. These results indicate the use of HfCl₄ as the inorganic additive may facilitate forming deposits (e.g., the coating 104) with large particles (e.g., particles of Al having a largest average dimension (e.g., diameter) of up to about 30 μm).

### Example V: Deposition Using Organic Additives

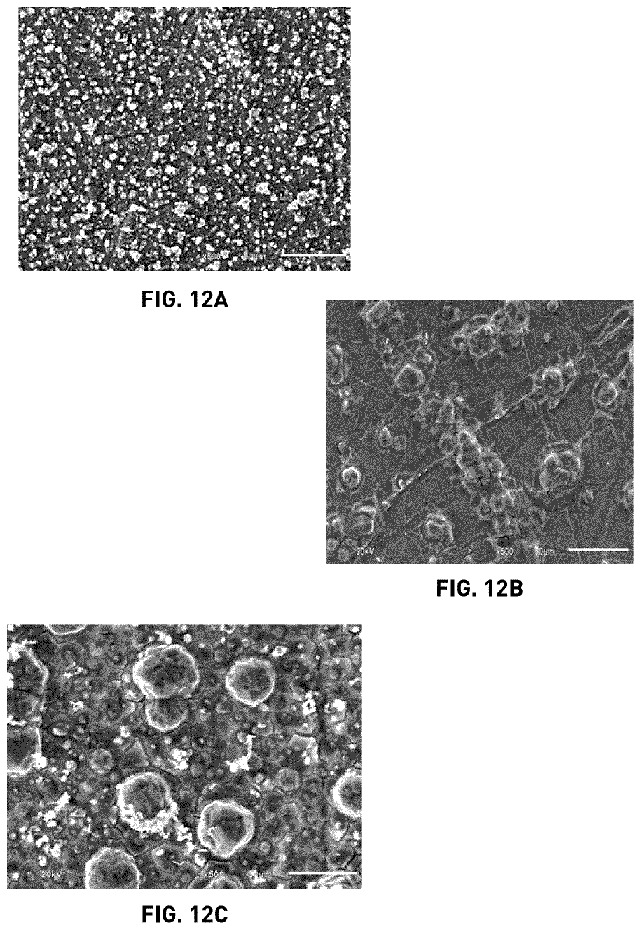

FIG. 12A is an SEM image of Al deposits (e.g., coating 104) formed on a copper (Cu) sheet (e.g., the working electrode (substrate) 114) from an electrolyte solution 106 comprising AlBr₃ (e.g., as the precursor 120) and 1-butyl-3-methylimidazolium tetrachloroaluminate (e.g., as the imidazolium-based tetrahalo-metallate 108) with bis(cyclopentadienyl)titanium dichloride (C₁₀H₁₀Cl₂Ti) as an organic additive 122 at room temperature. These results indicate organic additives 122 such as bis(cyclopentadienyl)titanium dichloride (C₁₀H₁₀Cl₂Ti) (or other metal-organic compounds of this class) may have high solubility in the imidazolium-based tetrahalo-metallate 108 and may affect the nucleation-growth kinetics of the metal (e.g., the Al) being electrodeposited onto the working electrode (substrate) 114, leading to the formation of fine-particle deposits (e.g., the coating 104). It is contemplated that changes to the ligand and/or metal atom of the metal-organic compound (e.g., the additive 122) may facilitate adjustment to the properties of the metal (e.g., Al) deposit (e.g., the coating 104).

FIG. 12B is an SEM image of Al deposits (e.g., coating 104) formed on a copper (Cu) sheet (e.g., the working electrode (substrate) 114) from an electrolyte solution 106 comprising AlBr₃ (e.g., the precursor 120) and 1-butyl-3-methylimidazolium tetrachloroaluminate (e.g., as the imidazolium-based tetrahalo-metallate 108) with triphenyl phosphate ((C₆H₅)₃PO₄) as an organic additive 122 at room temperature. In comparison to the image of FIG. 10A—which resulted from use of the same precursor 102 and imidazolium-based tetrahalo-metallate 108 as that of FIG. 12B, but without the organic additive 122—the image of FIG. 12B shows a different morphology caused by the addition of an organic phosphate (e.g., the organic additive 122). Therefore, it is contemplated that use of other organic phosphates (e.g., as the additive(s) 122) that can dissolve in the electrolyte solution 106 will change the morphology and/or other properties of the deposits (e.g., the coating 104).

FIG. 12C is an SEM image of Al deposits (e.g., coating 104) formed on a copper (Cu) sheet (e.g., the working electrode (substrate) 114) from an electrolyte solution 106 comprising AlBr₃ (e.g., the precursor 120) and 1-butyl-3-methylimidazolium tetrachloroaluminate (e.g., as the imidazolium-based tetrahalo-metallate 108) with acetamide (C₂H₅NO) as an organic additive 122 at room temperature. Acetamide is the simplest amide derived from acetic acid. Its dissolution into the electrolyte solution 106 may change the physicochemistry (e.g., viscosity, electrical conductivity) of the electrolyte solution 106 and affect the kinetics of the deposition (e.g., of the coating 104). This may lead to formation of deposits (e.g., coatings 104) of different morphology and particle sizes. Based on these results, it is contemplated that the use of more complicated amides (e.g., as the additive 122(s)) may facilitate control of the properties of the metal-based deposit (e.g., the coating 104).

While the present disclosure has been described herein with respect to certain illustrated and/or otherwise disclosed embodiments, those of ordinary skill in the art will recognize and appreciate that it is not so limited. Rather, many additions, deletions, and modifications to the illustrated and/or otherwise disclosed embodiments may be made without departing from the scope of the disclosure as hereinafter claimed, including legal equivalents thereof. In addition, features from one embodiment may be combined with features of another embodiment while still being encompassed within the scope of the disclosure as contemplated. Further, embodiments of the disclosure have utility with different and various devices, materials, and industries.

What is claimed is:

1. An electrochemical deposition system for electrochemical deposition of a metal-based material, the electrochemical deposition system comprising:
an electrolyte solution comprising:
at least one imidazolium-based tetrahalo-metallate compound; and
at least one metal-containing compound of a metal of the metal-based material to be electrodeposited;
at least one working electrode, on which the metal-based material is to be electrodeposited, configured to be exposed to the electrolyte solution; and
at least one counter electrode in contact with the electrolyte solution.

2. The electrochemical deposition system of claim 1, wherein:
the at least one imidazolium-based tetrahalo-metallate compound comprises at least one alkyl-imidazolium tetrahalo-metallate compound.

3. The electrochemical deposition system of claim 2, wherein:
the at least one alkyl-imidazolium tetrahalo-metallate compound comprises at least one of:
1-ethyl-3-methylimidazolium tetrachloroaluminate [EMeIm]AlCl₄; and
1-butyl-3-methylimidazolium tetrachloroaluminate [BMeIm]AlCl₄.

4. The electrochemical deposition system of claim 1, wherein the at least one metal-containing compound of the metal of the metal-based material to be electrodeposited comprises at least one of a metal bromide and a metal chloride.

5. The electrochemical deposition system of claim 4, wherein the at least one metal-containing compound of the metal comprises at least one salt of aluminum (Al), cobalt (Co), nickel (Ni), zirconium (Zr), iron (Fe), uranium (U), or a metal alloy thereof.

6. The electrochemical deposition system of claim 1, wherein the electrolyte solution further comprises at least one organic additive.

7. The electrochemical deposition system of claim 6, wherein the at least one organic additive comprises at least one of bis(cyclopentadienyl)titanium dichloride (C₁₀H₁₀Cl₂Ti), bis(cyclopentadienyl)zirconium dichloride (C₁₀H₁₀Cl₂Zr), a phosphate, an ester, and an amide.

8. The electrochemical deposition system of claim 1, wherein the electrolyte solution further comprises at least one inorganic additive.

9. The electrochemical deposition system of claim 8, wherein the at least one inorganic additive comprises at least one multi-valence halide.

10. The electrochemical deposition system of claim 1, wherein the at least one working electrode comprises glassy carbon or a metal substrate.

11. The electrochemical deposition system of claim 1, further comprising at least one reference electrode in contact with the electrolyte solution, the at least one reference electrode comprising at least one of an elemental metal, a metal-based material, and a carbon-based material.

12. The electrochemical deposition system of claim 1, wherein the electrolyte solution is liquid at a temperature within a range from about 20° C. (about 68° F.) to about 25° C. (about 77° F.).

13. A method for forming a metal-based material on a substrate, the method comprising:
forming an electrolyte solution comprising an ionic liquid comprising at least one imidazolium-based tetrahalo-metallate material and at least one metal halide;
disposing at least one counter electrode at least partially within the electrolyte solution; and
exposing the substrate to the electrolyte solution while applying an electric current flowing through the at least one counter electrode and the substrate or an electric potential between at least one reference electrode and the substrate to electrochemically deposit a metal-based material on at least one surface of the substrate.

14. The method of claim 13, wherein the method comprises maintaining an operation temperature to not exceed about 200° C. (about 392° F.).

15. The method of claim 13, wherein the method comprises maintaining an operation temperature within a range of from about 20° C. (about 68° F.) to about 25° C. (about 77° F.).

16. The method of claim 13, wherein exposing the substrate to the electrolyte solution comprises at least partially submerging the substrate within the electrolyte solution.

17. The method of claim 13, wherein exposing the substrate to the electrolyte solution comprises expelling the electrolyte solution through a nozzle toward the substrate.

18. The method of claim 13, further comprising, prior to the exposing, applying and modulating an electric potential applied to remove impurities from or to roughening the at least one surface of the substrate.

19. The method of claim 13, wherein forming the electrolyte solution comprises combining the at least one imidazolium-based tetrahalo-metallate material and the at least one metal halide, the at least one imidazolium-based tetrahalo-metallate comprising both aluminum (Al) and chlorine (Cl), the at least one metal halide further comprising the aluminum (Al) and chlorine (Cl).

20. An electrochemical deposition system, comprising:
an electrolyte solution within a container, the electrolyte solution consisting essentially of a non-aqueous ionic liquid comprising:
at least one imidazolium-based tetrachloroaluminate; and
at least one aluminum salt precursor material;
at least one counter electrode in contact with the electrolyte solution; and
at least one working electrode configured to be exposed to the electrolyte solution.

21. The electrochemical deposition system of claim 20, wherein:
the at least one imidazolium-based tetrachloroaluminate comprises at least one of 1-ethyl-3-methylimidazolium tetrachloroaluminate and 1-butyl-3-methylimidazolium tetrachloroaluminate;
the at least one aluminum salt precursor material comprises at least one of aluminum chloride (AlCl₃) and aluminum bromide (AlBr₃); and
the non-aqueous ionic liquid is configured to be maintained at a temperature within a range from about 20° C. to about 25° C.

22. The electrochemical deposition system of claim 20, further comprising:
at least one nozzle communicating from the container and directed toward the at least one working electrode, the at least one working electrode being external to the container; and
at least one electrochemical arm in operable communication with at least one of the container and the at least one working electrode.
